(19) United States
(12) Patent Application Publication
(10) Pub. No.: US 2007/0243009 A1
(43) Pub. Date: Oct. 18, 2007

(54) Paint applicator

(76) Inventor: Miguel Wang, Taichung City (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/486,920

(22) Filed: Jul. 14, 2006

(30) Foreign Application Priority Data
Apr. 18, 2006 (TW) 095113781

(51) Int. Cl. A46B 11/02; B05C 17/00

(52) U.S. Cl. 401/188 R; 401/197

(57) ABSTRACT

A paint applicator includes a handle, a paint applying member, a lever, a container, a pump, and first and second tubing sections. The pump includes a chamber mounted on the handle, and a pumping assembly slidably mounted inside the chamber and actuated by an actuating section of the lever. The first tubing section interconnects a connecting hole of the handle and the pump. The second tubing section interconnects the container and the chamber. The lever is operable to actuate the pump to pump paint from the container to the paint applying member through the second tubing section, the chamber, the first tubing section, and the handle.

### CROSS-REFERENCE TO RELATED APPLICATION

This application claims priority of Taiwanese Application No. 095113781, filed on Apr. 18, 2006.

### BACKGROUND OF THE INVENTION

1. Field of the Invention

The invention relates to a paint applicator, more particularly to a paint applicator which can supply paint continuously through a hand pressing action.

2. Description of the Related Art

Referring to FIG. 1, a conventional paint applicator includes a paint applying member 10, a tubular stem 11, and a pump 100. The tubular stem 11 is fluidly connected to a paint supply 12, and is extendible so as to permit the paint applying member 10 to reach a desirable height. The tubular stem 11 further includes a control valve 111 for controlling the supply of the paint from the paint supply 12 to the paint applying member 10.

However, since the pump 100 has relatively large weight and volume, is relatively expensive, and is required to be driven by electric power, the conventional paint applicator is limited for use by a professional painter. Furthermore, since it is not frequent for a general consumer to conduct the painting work, it is desirable to provide a paint applicator that is disposable after use. Additionally, since the tubular sections of the tubular stem 11 are connected to each other by screwing, they are liable to loosen to result in leakage of paint.

### SUMMARY OF THE INVENTION

Therefore, the object of the present invention is to provide a paint applicator which can supply paint continuously and relatively easily through a hand pressing action, and which is relatively inexpensive.

Accordingly, in one aspect of this invention, a paint applicator includes a handle, a paint applying member, a lever, a container, a pump, a first tubing section, and a second tubing section. The handle includes a top portion, a bottom portion, and a middle portion extending between the top and bottom portions. The top portion includes a first connecting hole and a second connecting hole connected fluidly to the first connecting hole. The paint applying member communicates fluidly with the first connecting hole. The lever is pivotally connected to the middle portion of the handle, and includes an actuating section proximate to the top portion of the handle, and an operating section opposite to the actuating section. The container is mounted between the handle and the paint applying member. The pump includes a chamber mounted on the handle, and a pumping assembly slidably mounted inside the chamber and actuated by the actuating section of the lever. The first tubing section interconnects the second connecting hole and the pump. The second tubing section interconnects the container and the chamber. The lever is operable to actuate the pump to pump paint from the container to the paint applying member through the second tubing section, the chamber, the first tubing section, and the handle.

In another aspect of this invention, a paint applicator includes a handle, a paint applying member, a pump, and a lever. The paint applying member is connected fluidly to the handle. The pump is adapted to transport paint to the paint applying member and, includes a chamber mounted on the handle, a valve port disposed at one end of the chamber, a valve element disposed in the chamber to close the valve port, a plunger inserted slidably into the chamber for moving toward or away from the valve port, a piston disposed within the chamber and connected to the plunger, and a resilient element disposed between the valve port and the plunger so as to bias the valve element to close the valve port and to urge the plunger to move away from the valve element. The lever is pivotally connected to the handle and has an actuating section to move the plunger toward the valve port, and an operating section operable to move the actuating section.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional paint applicator;

FIG. 2 is a sectional view of a preferred embodiment of a paint applicator according to this invention;

FIG. 3 is an enlarged fragmentary sectional view of the preferred embodiment;

FIG. 4 is a sectional view of a tube connector used in the preferred embodiment;

FIG. 5 is a sectional view of the tube connector taken along line 5-5 in FIG. 4;

FIG. 6 is a sectional view of a pump used in the preferred embodiment; and

FIGS. 7, 8, and 9 are sectional views illustrating the operation of the preferred embodiment.

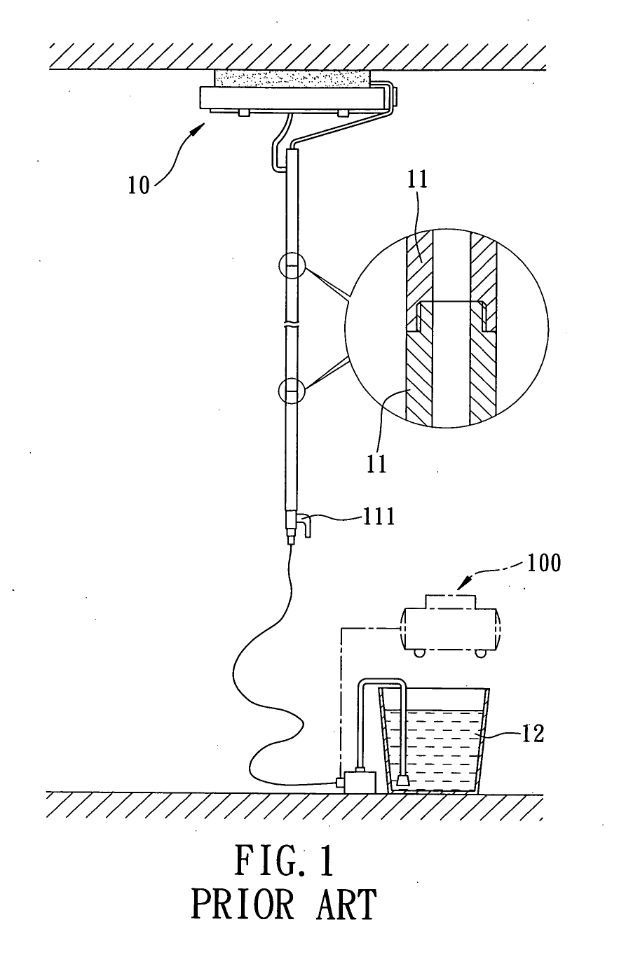

### DETAILED DESCRIPTION OF THE PREFERRED EMBODIMENT

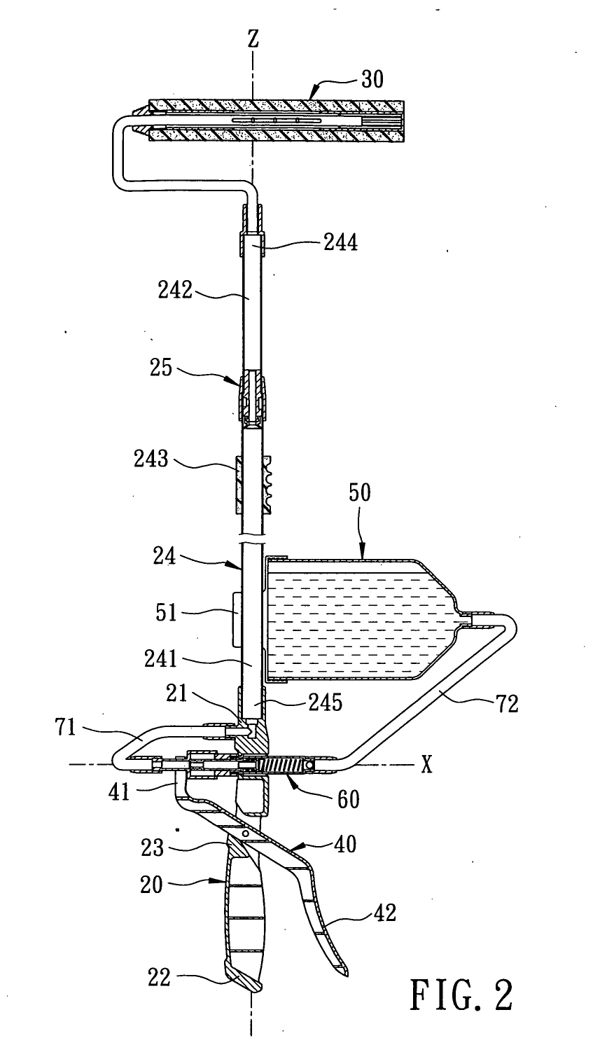

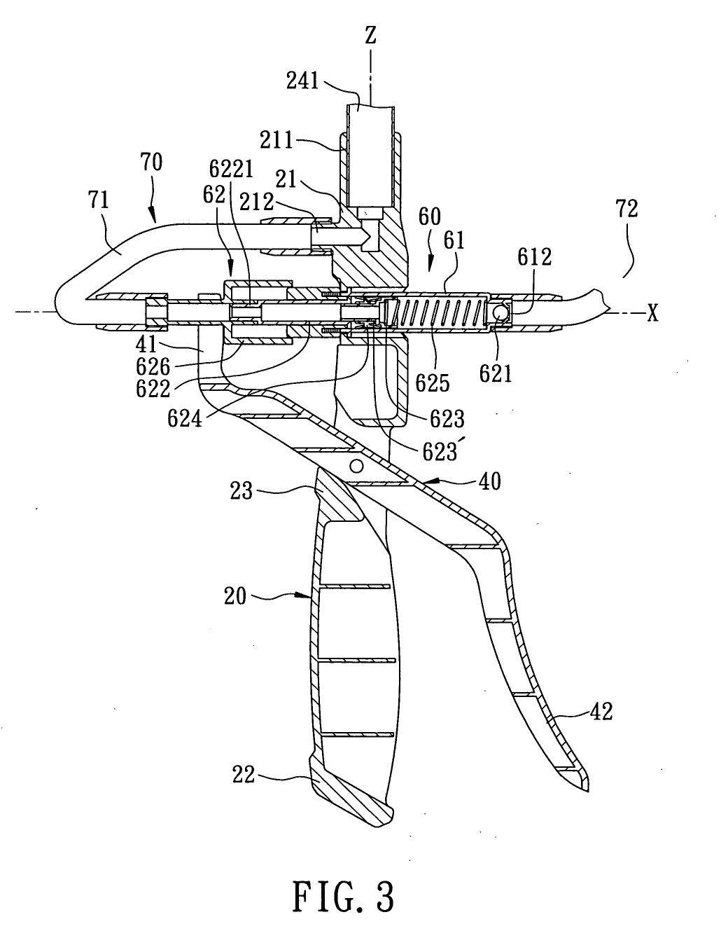

Referring to FIGS. 2 and 3, the preferred embodiment of a paint applicator according to this invention is shown to include a handle 20, a paint applying member 30, a tubular stem 24 connected fluidly to the handle 20 and the paint applying member 30, a lever 40, a container 50, a pump 60, a first tubing section 71, and a second tubing section 72.

The handle 20 extends toward the paint applying member 30, and includes a top portion 21, a bottom portion 22, and a middle portion 23 extending between the top and bottom portions 21,22.

The top portion 21 includes a first connecting hole 211 extending toward the paint applying member 30 along a first direction (Z), and a second connecting hole 212 connected fluidly to the first connecting hole 211 and extending along a second direction (X) transverse to the first direction (Z).

The tubular stem 24 is connected fluidly to the first connecting hole 211 of the handle 20 and the paint applying member 30. Specifically, the tubular stem 24 has a top end 244 connected to the paint applying member 30, and a bottom end 245 fitted in the first connecting hole 211 of the handle 20. The tubular stem 24 includes a tube connector 25, a first tube 241 connected to the first connecting hole 211, a second tube 242 connected to the paint applying member 30 and coupled to the first tube 241 through the tube connector 25, and a grip 243 mounted on the first tube 241.

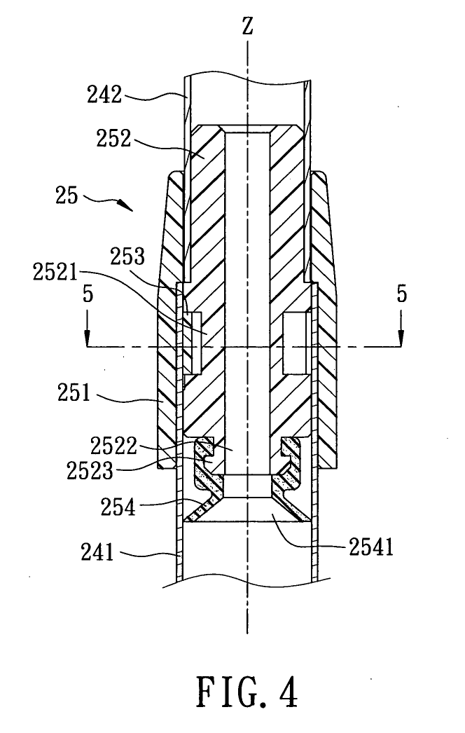

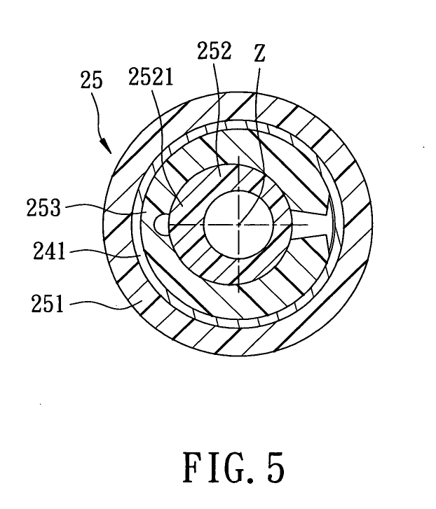

Referring to FIGS. 2, 4, and 5, the tube connector 25 includes an outer tube 251 sleeved around adjacent ends of the first and second tubes 241,242 and fixed to the first tube 241, an inner tube 252 disposed in the adjacent ends of the first and second tubes 241,242 and fixed to the second tube 242, a locking ring 253, and a leak-proof ring 254 mounted on the inner tube 252 and abutting against the first tube 241. The inner tube 252 has an eccentric part 2521 eccentric to the inner tube 252 and the first and second tubes 241,242. The locking ring 253 is disposed between the eccentric part 2521 and an inner surface of the first tube 241. When the tubular stem 24 is extended to a desired extent, the inner tube 252 is rotated by rotating the second tube 242 relative to the first tube 241 so that the eccentric part 2521 of the inner tube 252 is rotated to expand the locking ring 253 outwardly so as to fasten the second tube 242 relative to the first tube 241.

The inner tube 252 has a constricted end 2523 and a tube hole 2522 extending to the constricted end 2523. The leak-proof ring 254 is fixed to the constricted end 2523 and has a truncated-cone portion 2541 extending from the constricted end 2523 to the inner surface of the first tube 241 and abutting against the inner surface of the first tube 241.

Referring again to FIGS. 2 and 3, the paint applying member 30 is a paint roller, and communicates fluidly with the first connecting hole 211 of the handle 20 via the tubular stem 24.

The lever 40 is pivotally connected to the middle portion 23 of the handle 20, and includes an actuating section 41 proximate to the top portion 21 of the handle 20, and an operating section 42 opposite to the actuating section 41 and operable to move the actuating section 41.

The container 50 is removably mounted on the tubular stem 24 between the handle 20 and the paint applying member 30 via a fixing seat 51. Paint is contained in the container 50.

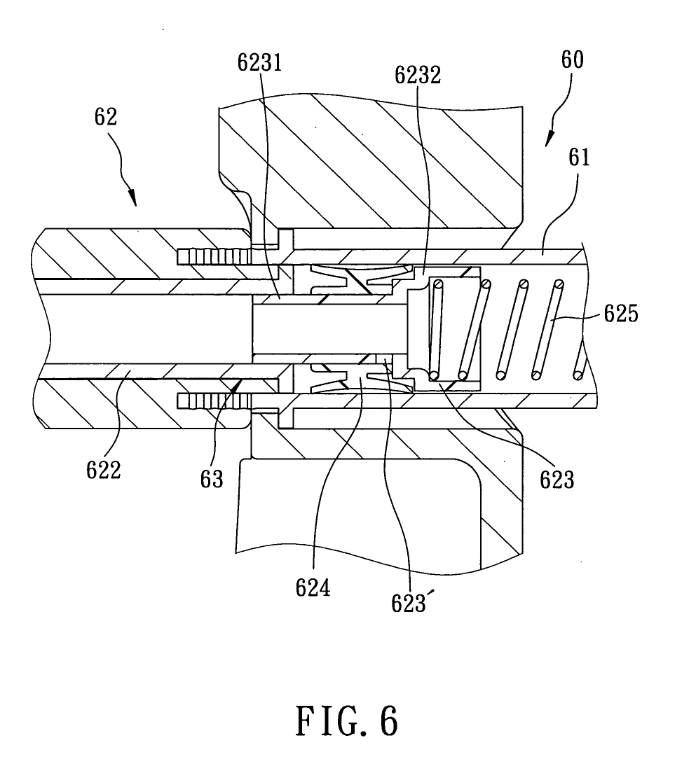

Referring to FIGS. 2, 3, and 6, the pump 60 is adapted to transport the paint in the container 50 to the paint applying member 30, and includes a chamber 61 mounted on the handle 20, and a pumping assembly 62 slidably mounted inside the chamber 61 and actuated by the actuating section 41 of the lever 40.

The chamber 61 includes a valve port 612 at one end to fluidly communicate the chamber 61 with the second tubing section 72, and a valve element 621 mounted in the chamber 61 to close the valve port 612. The valve element 621 used in the preferred embodiment is a spherical body. The pumping assembly 62 includes a plunger 63 inserted slidably into the chamber 61 for moving toward or away from the valve element 621, a piston 624 disposed within the chamber 61 and connected to the plunger 63, and a resilient element 625 disposed between the valve port 612 and the plunger 63 so as to bias the valve element 621 to close the valve port 612 and to urge the plunger 63 to move away from the valve element 621. The resilient element 625 used in this preferred embodiment is a compressible spring.

The plunger 63 has a plunger tube 622 having one end 6221 extending outwardly of the chamber 61 to be actuated by the actuating section 41, and a piston holder tube 623 having an insert end 6231 inserted into and connected fluidly to the plunger tube 622, a hollow enlarged end 6232 extending away from the plunger tube 622 to abut against the resilient element 625, and a radial hole 623′ formed in the piston holder tube 623 between the insert end 6231 and the hollow enlarged end 6232. The piston 624 abuts sealingly against an inner surface of the chamber 61 and is sleeved around the piston holder tube 623. The piston holder tube 623 is slidable limitedly relative to the piston 624 to permit the radial hole 623′ to be blocked or unblocked by the piston 624. The plunger 63 further has a cap 626 disposed outwardly of the chamber 61 and connected to the plunger tube 622. The lever 40 is pivoted to the handle 20 between the actuating section 41 and the operating section 42. The actuating section 41 abuts against the cap 626.

The first tubing section 71 interconnects the second connecting hole 212 and the plunger 63 of the pump 60. The second tubing section 72 interconnects the container 50 and the valve port 612 of the chamber 61.

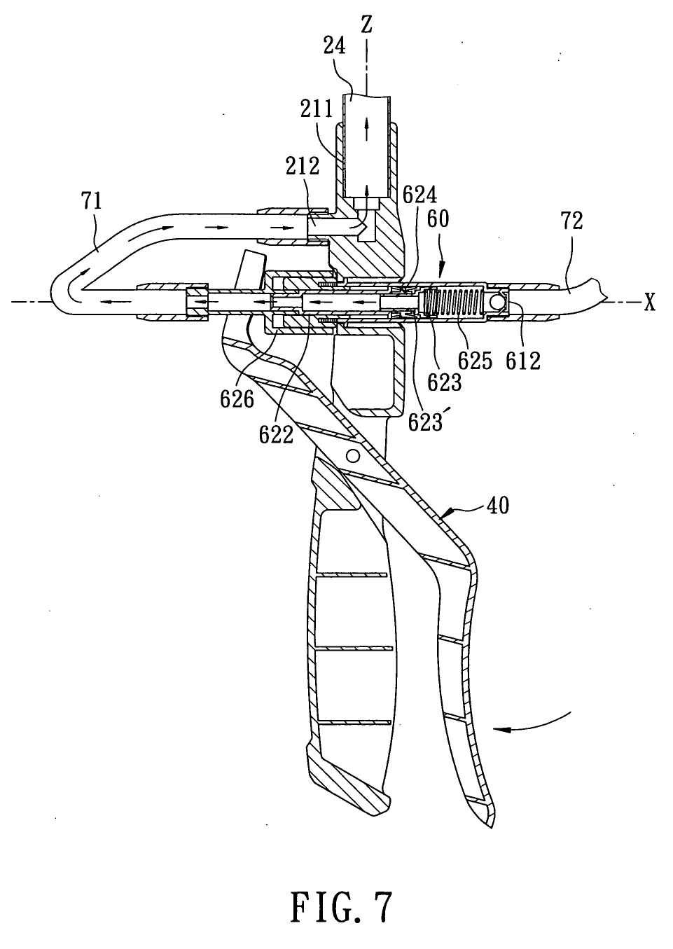

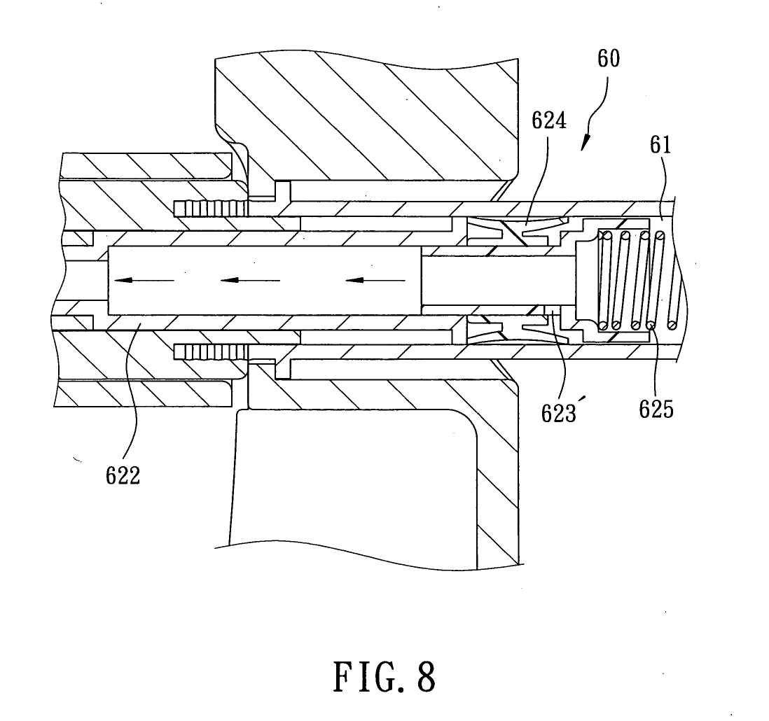

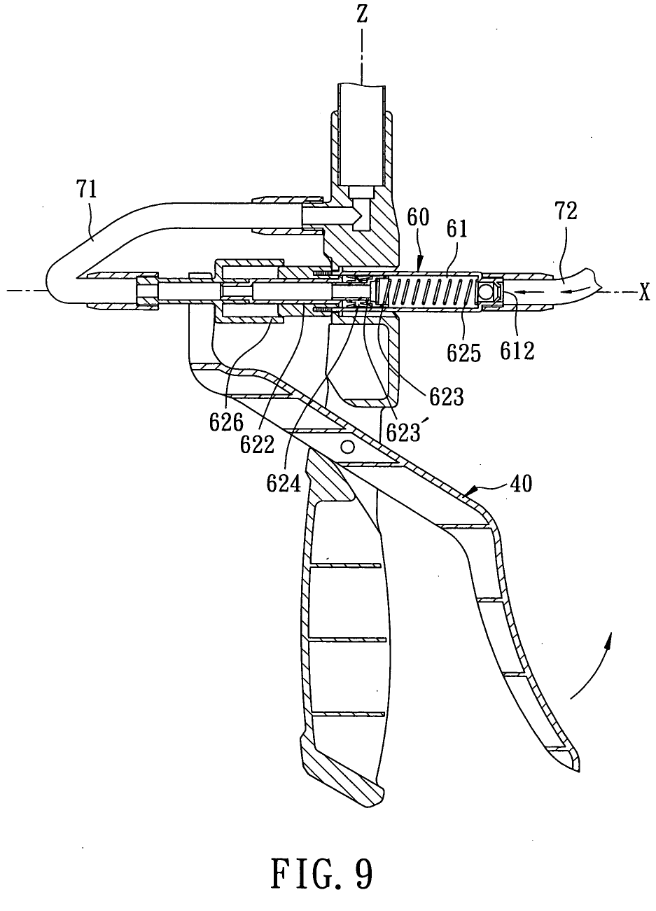

Referring to FIGS. 2, 7, 8, and 9, in use, the lever 40 is operable to actuate the pump 60 to pump the paint from the container 50 to the paint applying member 30 through the second tubing section 72, the chamber 61, the first tubing section 71, the handle 40, and the tubular stem 24. Specifically, the paint is pumped from the container 50 into the chamber 61 by operating the lever 40 repeatedly to actuate the pump 60. When the operating section 42 of the lever 40 is pressed, the resilient element 625 is compressed by the cap 626 and the plunger tube 622 so as to permit the radial hole 623′ to be unblocked by the piston 624. Therefore, the paint in the chamber 61 can flow to the paint applying member 30 via the radial hole 623′, the plunger tube 622, the cap 626, the first tubing section 71, the second connecting hole 212, the first connecting hole 211, and the tubular stem 24 (best shown in FIGS. 7 and 8). When the operating section 42 of the lever 40 is released, the plunger tube 622 and the cap 626 are moved away from the valve element 621, and the valve element 621 is in turn moved away from the valve port 612 so as to open the valve port 612. Therefore, the paint can be transported from the container 50 into the chamber 61 once again. The paint can be transported from the container 50 to the paint applying member 30 continuously by repeating the aforesaid operation until the container 50 is empty. Furthermore, the first and second tubes 241,242 of the tubular stem 24 can be fastened to each other by the tube connector 25.

In view of the aforesaid, the aforesaid disadvantage encountered in the prior art can be overcome by this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A paint applicator, comprising:
a handle including a top portion, a bottom portion, and a middle portion extending between said top and bottom portions, said top portion including a first connecting hole and a second connecting hole connected fluidly to said first connecting hole;
a paint applying member communicating fluidly with said first connecting hole;
a lever pivotally connected to said middle portion of said handle, and including an actuating section proximate to said top portion of said handle, and an operating section opposite to said actuating section;
a container mounted between said handle and said paint applying member;
a pump including a chamber mounted on said handle, and a pumping assembly slidably mounted inside said chamber and actuated by said actuating section of said lever;
a first tubing section interconnecting said second connecting hole and said pump; and
a second tubing section interconnecting said container and said chamber;
wherein said lever is operable to actuate said pump to pump paint from said container to said paint applying member through said second tubing section, said chamber, said first tubing section, and said handle.

2. The paint applicator as claimed in claim 1, wherein said first connecting hole extends toward said paint applying member along a first direction, said second connecting hole extending along a second direction transverse to said first direction.

3. The paint applicator as claimed in claim 1, further comprising a tubular stem connected fluidly to said first connecting hole and said paint applying member.

4. The paint applicator as claimed in claim 3, wherein said tubular stem includes a tube connector, a first tube connected to said first connecting hole, a second tube connected to said paint applying member and coupled to said first tube through said tube connector, and a grip mounted on one of said first and second tubes.

5. The paint applicator as claimed in claim 4, wherein said tube connector includes an outer tube sleeved around adjacent ends of said first and second tubes and fixed to said first tube, an inner tube disposed in said adjacent ends of said first and second tubes and fixed to said second tube, a locking ring, and a leak-proof ring mounted on said inner tube and abutting against one of said first and second tubes, said inner tube having an eccentric part eccentric to said inner tube and said first and second tubes, said locking ring being disposed between said eccentric part and an inner surface of said first tube.

6. The paint applicator as claimed in claim 5, wherein said inner tube has a constricted end and a tube hole extending to said constricted end, said leak-proof ring being fixed to said constricted end and having a truncated-cone portion that extends from said constricted end to said inner surface of said first tube and that abuts against said inner surface of said first tube.

7. The paint applicator as claimed in claim 1, wherein said chamber includes a valve port to fluidly communicate said chamber with said second tubing section, and a valve element mounted in said chamber to close said valve port, said pumping assembly including a plunger inserted slidably into said chamber for moving toward or away from said valve element, a piston disposed within said chamber and connected to said plunger, and a resilient element disposed between said valve port and said plunger so as to bias said valve element to close said valve port and to urge said plunger to move away from said valve element.

8. The paint applicator as claimed in claim 7, wherein said plunger has a plunger tube having one end extending outwardly of said chamber to be actuated by said actuating section, and a piston holder tube having an insert end inserted into and connected fluidly to said plunger tube, a hollow enlarged end extending away from said plunger tube to abut against said resilient element, and a radial hole formed in said piston holder tube between said insert end and said hollow enlarged end, said piston abutting sealingly against an inner surface of said chamber and being sleeved around said piston holder tube, said piston holder tube being slidable limitedly relative to said piston to permit said radial hole to be blocked or unblocked by said piston.

9. A paint applicator comprising:
a handle;
a paint applying member connected fluidly to said handle;
a pump adapted to transport paint to said paint applying member, and including a chamber mounted on said handle, a valve port disposed at one end of said chamber, a valve element disposed in said chamber to close said valve port, a plunger inserted slidably into said chamber for moving toward or away from said valve port, a piston disposed within said chamber and connected to said plunger, and a resilient element disposed between said valve port and said plunger so as to bias said valve element to close said valve port and to urge said plunger to move away from said valve element; and
a lever pivotally connected to said handle and having an actuating section to move said plunger toward said valve port, and an operating section operable to move said actuating section.

10. The paint applicator of claim 9, wherein said plunger has a plunger tube having one end extending outwardly of said chamber to be actuated by said actuating section, and a piston holder tube having an insert end inserted into and connected fluidly to said plunger tube, a hollow enlarged end extending away from said plunger tube to abut against said resilient element, and a radial hole formed in said piston holder tube between said insert end and said hollow enlarged end, said piston abutting sealingly against an inner surface of said chamber and being sleeved around said piston holder tube between said plunger tube and said hollow enlarged end, said piston holder tube being slidable limitedly relative to said piston to permit said radial hole to be blocked or unblocked by said piston.

11. The paint applicator of claim 9, further comprising a tubular stem having two ends connected respectively to said paint applying member and said handle, and a container disposed on said tubular stem and connected fluidly to said valve port.

12. The paint applicator of claim 11, wherein said handle has a top portion provided with first and second connecting holes above said chamber, said first and second connecting holes being connected fluidly to each other, said tubular stem having a bottom end fitted in said first connecting hole, said second connecting hole extending transversely of and being connected fluidly to said first connecting hole, said plunger being connected fluidly to said second connecting hole.

13. The paint applicator of claim 12, further comprising a flexible first tubing section connected fluidly to said plunger and said second connecting hole, and a second tubing section connected fluidly to said chamber and said container.

14. The paint applicator of claim 10, wherein said plunger further has a cap disposed outwardly of said chamber and connected to said plunger tube, said lever being pivoted to said handle between said actuating section and said operating section, said actuating section abutting against said cap.
